(19) United States
(12) Patent Application Publication
(10) Pub. No.: US 2011/0154997 A1
(43) Pub. Date: Jun. 30, 2011

(54) Juicer Structure

(76) Inventor: Jin Yi Huang, Antin Hsiang (TW)

(21) Appl. No.: 12/647,054

(22) Filed: Dec. 24, 2009

(51) Int. Cl. A23N 1/00

(52) U.S. Cl. 99/508; 99/510

(57) ABSTRACT

A juicer structure is disclosed, which features a clutch fixed at the terminal of a driving unit to be connected with a blade turntable, where the connected media is made of plural tiers of joining surfaces. A radial rod is set up in the joining surface corresponding to each bead hole. A bead hole allows protrusion of curved side at one end of a rod. And each curved side of the rod is lodged in the corresponding embedding hole, which establishes a firm coupling between the blade turntable and the clutch. The clutch actually is a multiple-tier design, and joins the blade turntable in an axial coupling with the support by the rod, which substantially boosts the stability of the joining with the blade turntable.

### BACKGROUND OF THE INVENTION

1. Field of the Invention

This invention relates generally to a juicer structure and more particularly to one that is capable of boosting the stability and safety of the joining between its clutch and blade turntable.

2. Description of the Prior Art

As the living standard of people is constantly being lifted, the target for having quality life is almost inevitable to all consumers. The demand for a juicer, the traditionally unnecessary home appliance, is growing yearly, which facilitates the changing of consumer attitudes from pursuing the most fundamental demands of plain living only towards nutritious and healthy demands of select living. And that phenomenon further draws sizable attention towards the juicer. Prior juicers have a blade turntable fixed in the body and driven by a driving unit, where the food ingredients to be extracted are pressed on the blade turntable for being cut and ground by the blades. Meanwhile, the extracted juice is pushed out from the blade turntable by means of the exertion of centrifugal force as the blade turntable rotates, and the juice is then forced to pass through the filter which is fixed at the cylinder of the blade turntable, to achieve both extraction and filtering of the juice. The structure that driving unit drives the blade turntable to rotate is through a clutch which is fixed at the terminal of the driving unit, where the clutch is provided with gear notches at its joining end, which are embedded by the ribs at the joining end of the blade turntable, to enable the blade turntable to be driven by the driving unit. However, the joining between the clutch and the blade turntable is merely a plain enclosure and a single tier contact, which lacks radial linking force. Therefore, the blade turntable is not only lousy in coupling stability but possible to fall off from the clutch, which will probably bring about damage to safety. In the light of the aforementioned drawbacks of the prior art, this inventor conceived the idea for the advanced improvement, and eventually the endeavors gave birth to this invention.

### SUMMARY OF THE INVENTION

The objective of this invention is to provide a juicer structure that is able to boost the stability and safety of the joining between its clutch and blade turntable. To accomplish the aforementioned objects, this invention features plural tiers of joining surfaces near the terminal portion of the driving unit for the connection with the clutch of the blade turntable, where each joining surface is provided with a symmetrical bead hole. A bead hole allows protrusion of partial curved side at one end of a rod, where the rod is located in the clutch and pushed outward by a spring. The blade turntable is provided with an embedding holder which has plural tiers along its joining end to the clutch, where the inner diameters of the tiers are fit to the outer diameters of the joining surfaces of the clutch. And the embedding holder is provided with an embedding hole corresponding to each location of the protruded curved side of the rod at the corresponding joining surface. By means of the aforesaid setup, the linking of the blade turntable with the clutch is achieved by the joining of plural tiers of the embedding holder and of the joining surfaces. Each curved side of a rod is lodged in the corresponding embedding hole, which establishes a radial coupling between the two.

### BRIEF DESCRIPTION OF THE DRAWINGS

FIG. 1 is an outer view of an exemplary embodiment of this invention;

FIG. 2 is an exploded view of the middle member and the blade turntable of the first exemplary embodiment of this invention;

FIG. 3 is an exploded view of the blade turntable and the clutch of the first exemplary embodiment of this invention;

FIG. 4 is an exploded view of the structure of the clutch of the first exemplary embodiment of this invention;

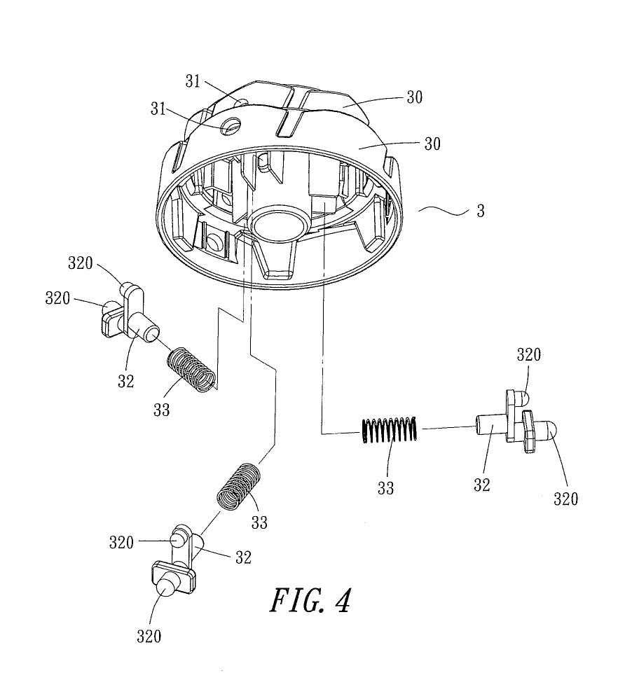

FIG. 5 is an assembled sectional view of the blade turntable and the clutch of the first exemplary embodiment of this invention;

FIG. 6 is a three-dimensional view of the structure of the blade turntable of the second exemplary embodiment of this invention;

FIG. 7 is an exploded view of the blade turntable and the clutch of the second exemplary embodiment of this invention;

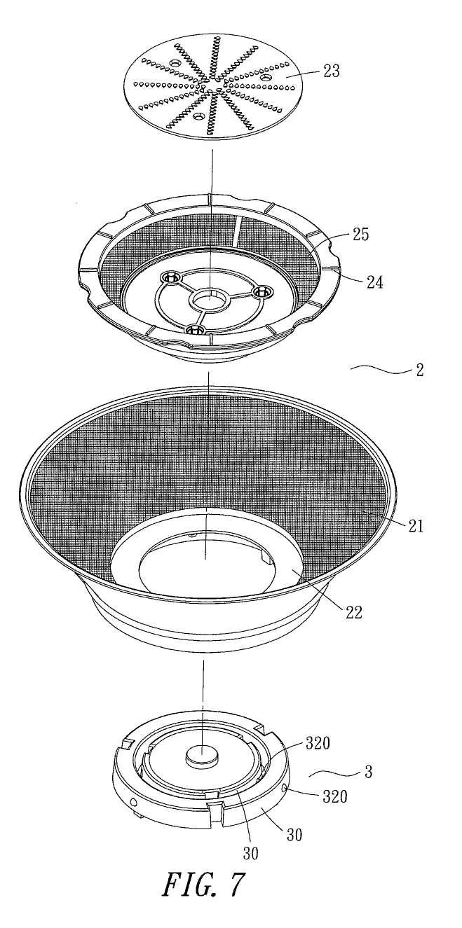

FIG. 8 is an exploded view of the structure of the clutch of the second exemplary embodiment of this invention; and

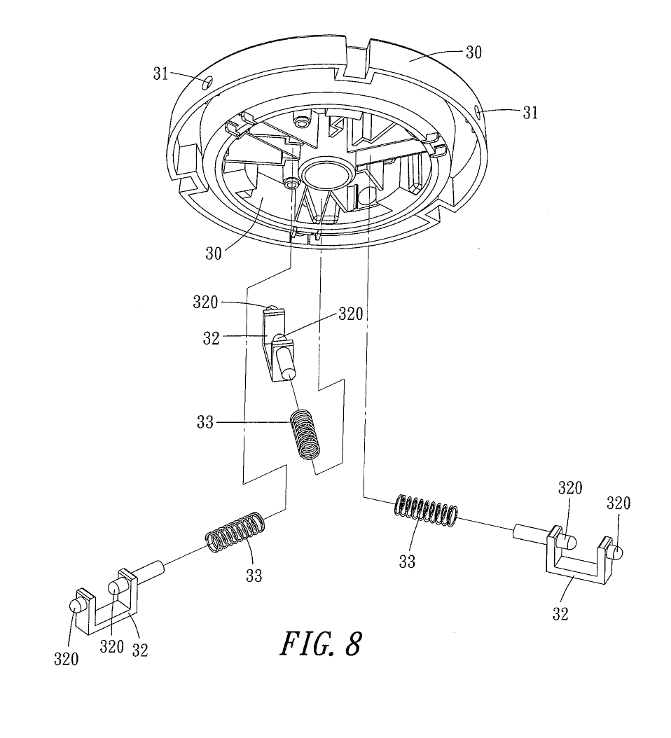

FIG. 9 is an assembled sectional view of the blade turntable and the clutch of the second exemplary embodiment of this invention.

### DETAILED DESCRIPTION OF THE INVENTION

To achieve the aforementioned objects of the present invention, the techniques adopted and the achievable function are detailed described with reference to the following exemplary embodiments.

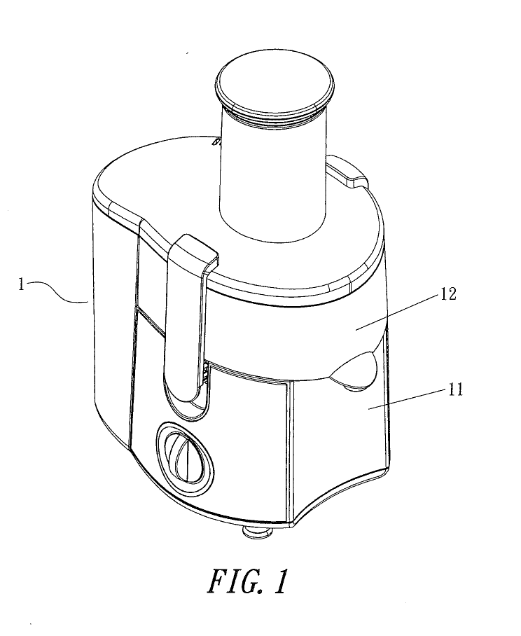

Referring to FIGS. 1˜4, the juicer of an exemplary embodiment of this invention comprises:

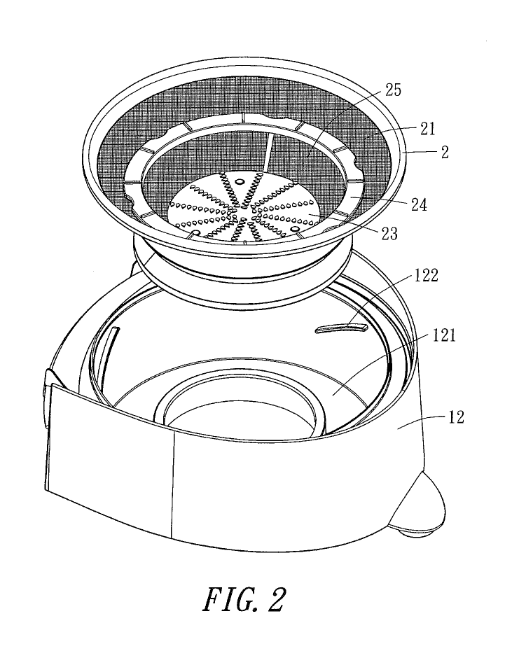

a body 1, comprising a core 11 and a middle member 12 placed on top of the core 11, where the core 11 is provided with a driving unit (for instance: motor) in its interior, while the middle member 12 is provided with a receptacle 121 in its interior, and the receptacle 121 has inclined protruded ribs 122 on its inner wall, which are part of the all-in-on shaping.
a blade turntable 2 (referring to FIGS. 2 & 3), set up in the receptacle 121 of the middle member 12, and at its bottom having axial embedding coupling with the clutch 3, which is at the terminal of the driving unit, to enable the driving unit to drive the blade turntable 2 for rotation. Aside from a first filter 21 set up around the blade turntable 2, a disk-shaped first blade 23 is set up on the bottom stand 22 in the first filter 21, and a hollow second blade 24 is set up on the top of the first blade 23, where a second filter 25 is built in between the first blade 23 and the second blade 24, to enable the second filter 25 to be placed inside the first filter 21, which boosts the efficiency of the juice filtering by exploiting both the first filter 21 and the second filter 25 during juice extraction. The aforesaid second blade 24 can function as a sharp blade and also as a rib for the squeeze. As the blade turntable 2 is driven by the driving unit for carrying out high speed rotation, the first blade 23 will proceed to grind, cut and squeeze the food ingredients on the bottom, while the second blade 24 will also grind, cut and squeeze the food ingredients as they float due to the high speed rotation. Through the joint efforts of the first blade 23 and the second blade 24, the efficiency of the juice extraction is boosted substantially. The declined protruded ribs 122 on the inner wall of the receptacle 121 of the middle member 12 are devised for changing the up airflow due to rotation downward, which helps to press the extracted ingredients for the advancement of the juice extraction.

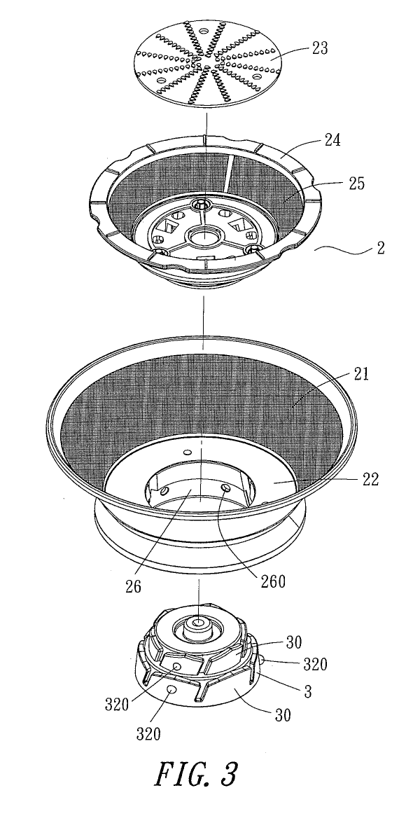

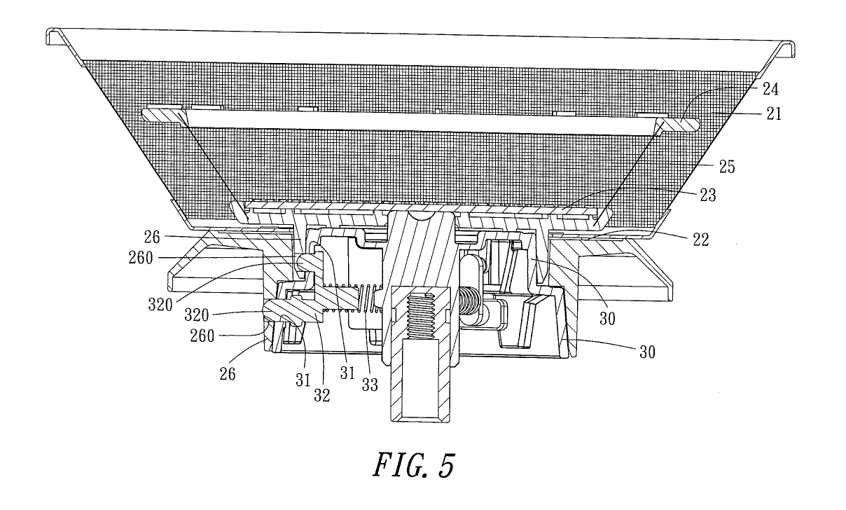

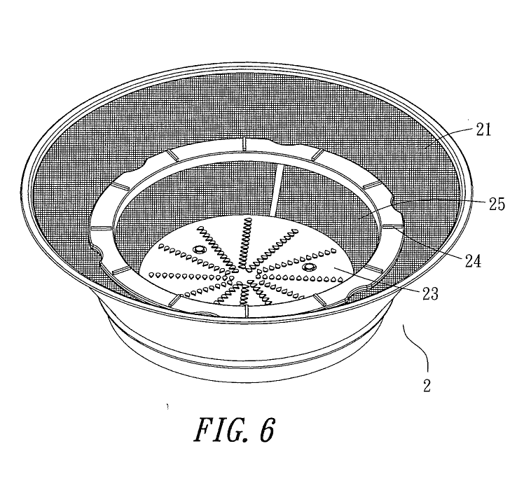

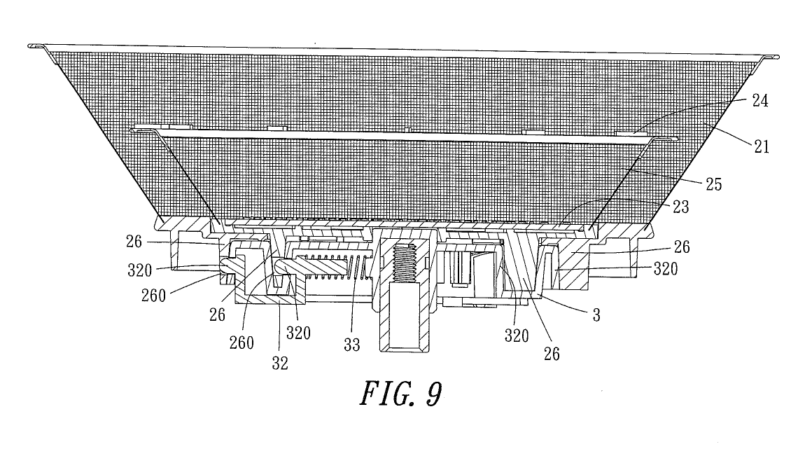

The aforesaid clutch 3 (referring to FIGS. 3 & 4), is made up of plural (two) tiers of joining surfaces 30, in the shape of top tier and bottom tier arrangement, where the outer diameter of the top tier is shorter than that of the bottom tier, and each joining surface 30 of one tier is provided with a symmetric bead hole 31. A radial rod 32 is set up in the joining surface 30 corresponding to each bead hole 31, where the rod 32 is joined with a spring 33 in the way that the spring 33 pushes the rod to have the top and bottom curved sides 320 at its end moved through the corresponding bead holes 31 and exposed on the joining surfaces 30 of the top and bottom tiers respectively. The blade turntable 2 is provided with an embedding holder 26 at the end connected to the clutch 3, where the inner diameters of the embedding holder 26 are fit to the outer diameters of the joining surfaces 30 of the clutch 3. The embedding holder 26 is also in the shape of top tier and bottom tier arrangement to join those tiers of the clutch 3. And the embedding holder 26 is provided with an embedding hole 260 corresponding to each location of the protruded curved side 320 of the rod 32 at the corresponding joining surface. Therefore, once the blade turntable 2 and the clutch 3 are connected together, the plural tiers of the embedding holder 26 and those of the joining surfaces 30 are joined together in a top and bottom arrangement. And each curved side 320 of a rod 32 is lodged in the corresponding embedding hole 260 (shown in FIG. 5), which establishes a firm coupling between the blade turntable 2 and the clutch 3. Unless a large force to pull the blade turntable 2 up to overcome the elastic force, it is unlikely for the blade turntable 2 and the clutch 3 to come off to each other along the axial direction. Referring to FIGS. 6˜9, the clutch 3 and the blade turntable 2 are in axial embedded coupling, to enable the blade turntable 2 driven by the driving unit to rotate. The plural (two) tiers of joining surfaces 30 of the clutch 3 to join the blade turntable 2 can be replaced by one plane and a design of inner tier and outer tier arrangement with a joining gap between the two. Each joining surface 30 of one tier is provided with a symmetrical bead hole 31. And a radial rod 32 is set up in the joining surface 30 corresponding to each bead hole 31, where the rod 32 is joined with a spring 33 in the way that the spring 33 pushes the rod to have the front and rear curved sides 320 at its end moved through the corresponding bead holes 31 and exposed on the joining surfaces 30 of the inner and outer tiers respectively. The blade turntable 2 is provided with an embedding holder 26 at the end connected to the clutch 3, where the inner diameters of the embedding holder 26 are fit to the outer diameters of the joining surfaces 30 of the clutch 3. The embedding holder 26 is also in the shape of inner tier and outer tier arrangement to join those tiers of the clutch 3. And the embedding holder 26 is provided with an embedding hole 260 corresponding to each location of the protruded curved side 320 of the rod 32 at the corresponding joining surface. Therefore, once the blade turntable 2 and the clutch 3 are connected together, the plural tiers of the embedding holder 26 and those of the joining surfaces 30 are joined together in an inner and outer arrangement. And each curved side 320 of a rod 32 is lodged in the corresponding embedding hole 260 (shown in FIG. 9), which establishes a firm coupling between the blade turntable 2 and the clutch 3. Unless a large force to pull the blade turntable 2 up to overcome the elastic force, it is unlikely for the blade turntable 2 and the clutch 3 to come off to each other along the axial direction.

Based on the foregoing description, this invention has at least the following advantages and features:
1.) The clutch is a multiple-tier design, and joins the blade turntable in an axial coupling with a springy rod, which substantially boosts the stability of the joining with the blade turntable.
2.) A design of multiple blades and filters, which is exploiting plural blades to grind, cut and squeeze food ingredients to lift the efficiency of juice extraction, and exploiting plural filters to boost the efficiency of juice filtering.
3.) The declined protruded ribs on the inner wall of the receptacle of the middle member are devised for changing the up airflow due to the rotation downward, which helps to press the extracted ingredients for the advancement of the juice extraction.

To sum up, the present invention is construed as not only novel but useful, thereby a patent application for the invention is then filed according to the patent law, which deserves your favorable examination and approval.

What is claimed is:

1. A juicer structure, comprising:
a body, comprising a core and a middle member placed thereon, where the core is provided with a driving unit therein, while the middle member is provided with a receptacle therein; and
a blade turntable, set up in the receptacle of the middle member, and having axial embedding coupling with a clutch at its bottom, where the clutch is located at the terminal of the driving unit, to enable said blade turntable driven by the driving unit for rotation; a filter being set up around said blade turntable, and a disk-shaped blade being set up on a bottom stand in the filter;
featuring: the joining between the clutch and said blade turntable being made of a plurality of tiers of joining surfaces, and each joining surface of one tier being provided with a symmetric bead hole, and a radial rod being set up in the joining surface corresponding to each bead hole, where each rod is joined with a spring in the way that the spring pushes the rod to have the curved side at one end of the rod moved through the corresponding bead hole and exposed on the corresponding joining surfaces; said blade turntable being provided with an embedding holder at the end connected to the clutch, where the inner diameter of the embedding holder is fit to the outer diameter of the joining surfaces of the clutch, and the embedding holder being provided with an embedding hole corresponding to each location of the protruded curved side of the rod, as said blade turntable and the clutch being connected together, the embedding holder and the joining surfaces being joined together in a plural-tier embedding, and each curved side of a rod being lodged in the corresponding embedding hole for an axial connection.

2. A juicer structure as in claim 1 wherein the plural tiers of joining surfaces between the clutch and said blade turntable are in the shape of top tier and bottom tier arrangement, and the outer diameter of the top tier being shorter than that of the bottom tier, while the embedding holder of said blade turntable has the matching design, where the curved sides at the end of the rod are set up in the way to enable the curved sides to moved through the corresponding bead holes and exposed on the joining surfaces of the top and bottom tiers respectively.

3. A juicer structure as in claim 1 wherein the plural tiers of joining surfaces between the clutch and said blade turntable are in one plane and an inner tier and outer tier arrangement design with a joining gap between the two, while the embedding holder of said blade turntable has the matching design, where the curved sides at the end of the rod are set up in the way to enable the curved sides to moved through the corresponding bead holes and exposed on the joining surfaces of the inner and outer tiers respectively.

4. A juicer structure as in claim 1 wherein the inner wall of the receptacle of the middle member is set up with a plurality of inclined protruded ribs.

5. A juicer structure as in claim 1 wherein a hollow second blade is set up on the top of the blade, and a second filter being built in between the two blades, to enable the second filter to be placed inside the inherent filter.
